(19) United States
(12) Patent Application Publication
(10) Pub. No.: US 2009/0176189 A1
(43) Pub. Date: Jul. 9, 2009

(54) METHOD AND SYSTEM FOR EXTRACTION OF BROKEN OBJECTS FROM ENCLOSED SPACES

(75) Inventor: Refael Hof, Kfar Yona (IL)

Correspondence Address: MERCHANT & GOULD PC, P.O. BOX 2903, MINNEAPOLIS, MN, 55402-0903, US

(73) Assignee: REDENT-NOVA LTD., Ra'anana (IL)

(21) Appl. No.: 11/719,719

(22) PCT Filed: Nov. 13, 2006
(86) PCT No.: PCT/IL06/01299

§ 371 Date: May 22, 2008

(30) Foreign Application Priority Data
Aug. 21, 2006 (IL) 177610

(51) Int. Cl. A61C 3/00; A61C 5/02

(52) U.S. Cl. 433/141; 433/224

(57) ABSTRACT

The present invention is an extraction system capable of easily removing an object having a hollow interior from an enclosed space. The system comprises an overtube that is at least partially insertable into the enclosed space, and a wire comprising an elongated portion, a handle and an insertion end comprising one or more catching members. The catching member is in a straight configuration when the insertion end is confined within the overtube and assumes an open configuration when the insertion end is situated out of the overtube. Initially, the wire is introduced into the enclosed space within the overtube and the wire is pushed out of the overtube such that the catching members will enter the hollow interior of the object. The use of the extraction system is illustrated for the case of extracting a piece of an endodontic file broken during a root canal procedure.

### FIELD OF THE INVENTION

The present invention relates to an extraction system. In particular, the present invention relates to a method and system for extracting an object having a hollow interior from an enclosed space.

### BACKGROUND OF THE INVENTION

When performing a procedure with an instrument in an enclosed space, such as a canal or channel, failure and breakage of the instrument may occur. In order to continue working, the broken-off part of the instrument must be removed. The time spent on removing the broken instrument may cause significant delays as well as an increase in the costs involved with the procedure. Additionally, during the process of removing the instrument, possibly irreparable damage may be caused to the space itself.

One example illustrative of this problem is from the field of dental instruments, specifically root canal procedures. During a root canal procedure, the dentist (or, endodontist) typically uses an endodontic file to remove tissue remnants, while shaping and disinfecting the canal space. A conventional file is a solid tool having a round cross-section and a standardized cylindro-conic shape. If a file breaks within the canal, it is often difficult to remove the file due to the shape of the file and the narrow profile of the canal. Methods employed by the endodontist to remove the broken tool include enlarging the diameter of the canal and/or causing the broken tool to vibrate by applying ultrasound thereto, allowing the broken file to be more easily removed. However, these techniques have shortcomings. Enlarging the canal may lead to excessive and undesirable thinning of the canal wall, and vibration may result in damage to the tooth, if it works at all. If the endodontist is still unable to remove the file, the root canal treatment is not completed and the tooth is pulled.

A new endodontic file comprising an open and hollow structure has been developed, and is described in WO 05/070320 by the same applicant, the description of which, including reference cited therein, is incorporated herein by reference in its entirety.

The file is comprised of one or more longitudinal elements and one or more circumferential elements, which define the file's three-dimensional shape, which is that of a body comprised of a hollow space surrounding the longitudinal axis bounded radially by a wall having an open lattice-like structure. Among the many advantages of the new file, as described in the above-mentioned publication, is that in the event of failure within the canal, a suitable extraction system can be inserted to the canal and catch one of the openings of the file, thereby allowing the file to be easily removed from the canal.

It is therefore an object of the present invention to provide an extraction system that is capable of removing an object having an open structure from an enclosed space.

It is an additional object of the present invention to provide an extraction system that is capable of removing a broken-off piece of an endodontic file from a root canal.

Additional objects and advantages of the present invention shall become apparent as the description proceeds.

### SUMMARY OF THE INVENTION

The present invention relates to an extraction system for removing an object having a hollow interior from an enclosed space, the system comprising:
a. an overtube that is at least partially insertable into the enclosed space, wherein the external diameter of the overtube is less than the minimum diameter of the enclosed space from its opening to the top of the object situated within the space; and,
b. a wire situated within the overtube, the wire comprising an elongated portion, a handle and an insertion end comprising at least one catching member;
wherein, the catching member is in a straight configuration when the insertion end is within the overtube, and the catching member assumes an open configuration when the insertion end is situated out of the overtube.

At least the insertion end is made of a shape memory material, for instance, Nitinol.

The catching member may be chosen from any one of the group consisting of:
a. a hook; and,
b. a spike.

According to one aspect, the enclosed space is a root canal and the object is a broken piece of an endodontic file having an open lattice-like structure.

The present invention further relates to a method of removing an object having a hollow interior from a enclosed space, the method comprising:
a. providing an extraction system according to claim 1;
b. inserting the wire into the overtube such that the catching member is in its straight configuration;
c. inserting the overtube with the wire inside it into the open end of the enclosed space until the overtube contacts the object;
d. pushing the wire until the insertion end of the wire exits the overtube, thereby allowing the catching member to assume its open configuration inside said hollow interior of said object;
e. pulling slowly on the wire until the catching member catches an opening on the wall of the object or on a protrusion on its inner wall; and,
f. withdrawing the system and the attached object from the enclosed space.

### BRIEF DESCRIPTION OF THE DRAWINGS

In the drawings:

FIG. 1 illustrates a schematic front view showing a preferred embodiment of the components of the present invention;

FIGS. 2a and 2b illustrate a schematic front view of the assembled components of a first embodiment of the present invention, in an initial configuration (FIG. 2a) and a working configuration (FIG. 2b);

FIG. 3a illustrates an endodontic file having an open lattice-like structure as described in WO 05/070320;

FIG. 3b illustrates the endodontic file of FIG. 3a inserted to the root canal of a tooth;

FIG. 3c illustrates a schematic front view of a broken portion of the endodontic file of FIG. 3a, lodged in the root canal of a tooth;

FIGS. 4a through 4c illustrate a schematic front view of the sequence of operations required to remove the file from the canal of FIG. 3, using the extraction system of the present invention;

FIG. 5 illustrates a preferred embodiment of the present invention in an initial configuration;

FIG. 6a illustrates the preferred embodiment of the present invention in a working configuration; and

FIG. 6b illustrates an enlarged view of the distal tip of FIG. 6a.

### DETAILED DESCRIPTION OF THE PREFERRED EMBODIMENTS

The removal of a small object from an enclosed space without causing damage to either the object or the body, in which the enclosed space is situated, is often a difficult and time consuming task. The present invention solves this problem by providing an extraction system capable of easily removing an object having a hollow interior from an enclosed space.

The term, “enclosed space” as used herein refers to any narrow or confining space such as a canal, channel, tube, duct or passageway through a body.

A first embodiment of the components of the extraction system of the present invention is shown unassembled in FIG. 1. The extraction system, generally designated by the numeral (10), comprises an overtube (12) and a wire (14). Wire (14) comprises a handle portion (15) at its proximal end, an elongated portion (16) and an insertion end (18) having a distal end comprising a catching member, shown in this embodiment in the form of a hook (20). The distal end is shown in this figure in its open, or hooking configuration. Although only a single hook (20) is shown, it is understood that the distal end may comprise more than one catching member.

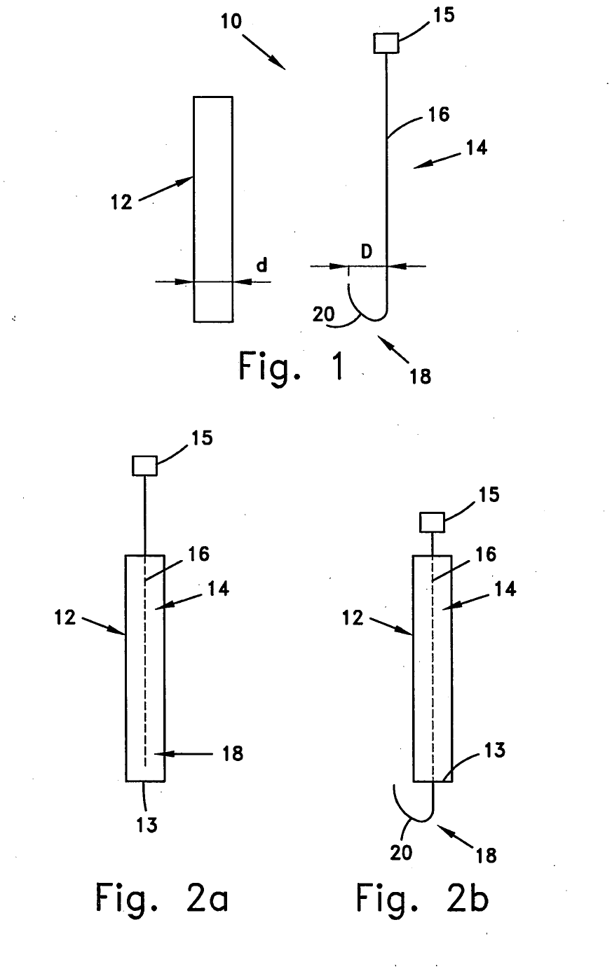

FIGS. 2a and 2b show the assembled extraction system (10) in its initial (FIG. 2a) and its working (FIG. 2b) configuration, wherein insertion end (18) is situated within overtube (12). In its initial configuration (FIG. 2a), insertion end (18) is surrounded by the wall of overtube (12), such that it is held in a straight configuration. This allows the diameter of the overtube 12 to be kept to a minimum. In its working configuration (FIG. 2b), insertion end (18) is fully extended out of overtube (12). When released from the confines of the wall, the insertion end assumes the shape of a hook (20). This is accomplished, for example by making at least insertion end (18) of wire (14) from a shape memory material, e.g. nickel titanium alloy (Nitinol). Wire (14) is treated such that its preferred shape memory shape is that shown in FIG. 1. When inserted to overtube (12), hook (20) is in a straight configuration and when handle (15) is pushed downward insertion end (18) out of the confines of overtube (20), the stress in the material is released, allowing it to assume its preferred shape.

Overtube (12) serves at least two functions in the present invention. First, overtube (12) provides the lateral support required to retain insertion end (18) in its straight configuration. Second, overtube (12) serves as a guide for wire (14) in order to reach the object, as described herein below. In order to fulfill the second function, the external diameter of overtube (12) must be less than the minimum diameter of the enclosed space, from its opening to the top of the object stuck in the space.

The enclosed space in which the object is lodged may have a curved profile. Depending on how deep the object is lodged within the space, overtube (12) may be required to bend and curve in order to reach the object. Overtube (12) is therefore preferably made of a flexible material, for example, plastic, and is preferably disposable. In some embodiments, one or both of the components of the system can be reusable and made of materials that can withstand repeated cleaning and sterilizing processes, for example cleaning in an ultrasonic bath and sterilizing in an autoclave.

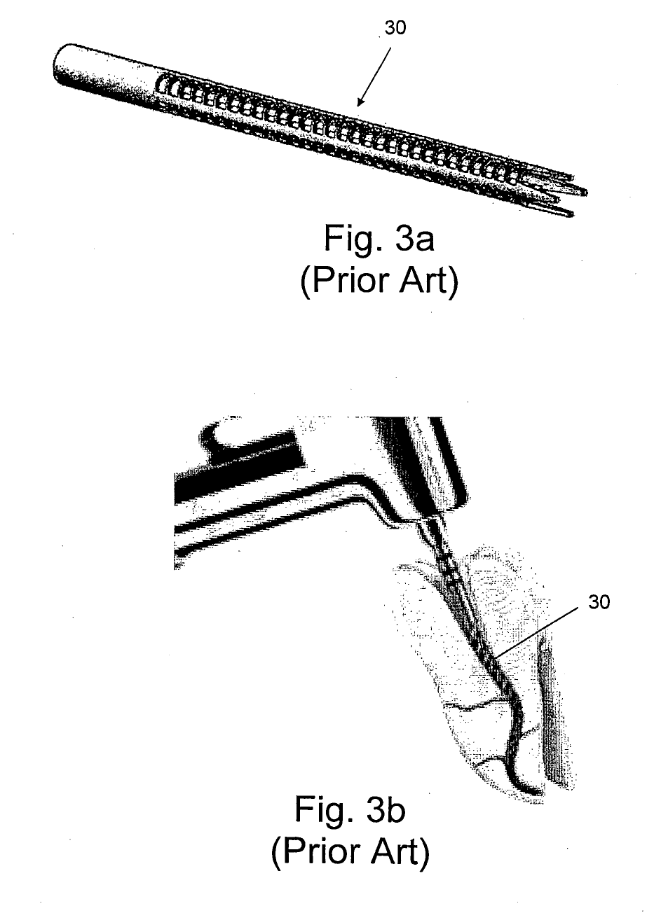

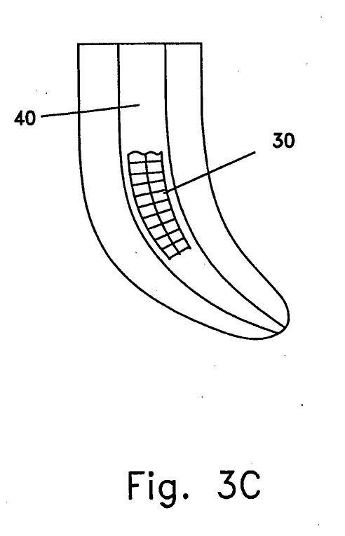

As an illustrative but non-limitative example of the present invention, an embodiment of an extraction system for removing an open structured endodontic file from a root canal will be described herein below. Such a file is illustrated in FIG. 7a and FIG. 10 of WO 05/070320, and shown herein as FIGS. 3a and 3b respectively.

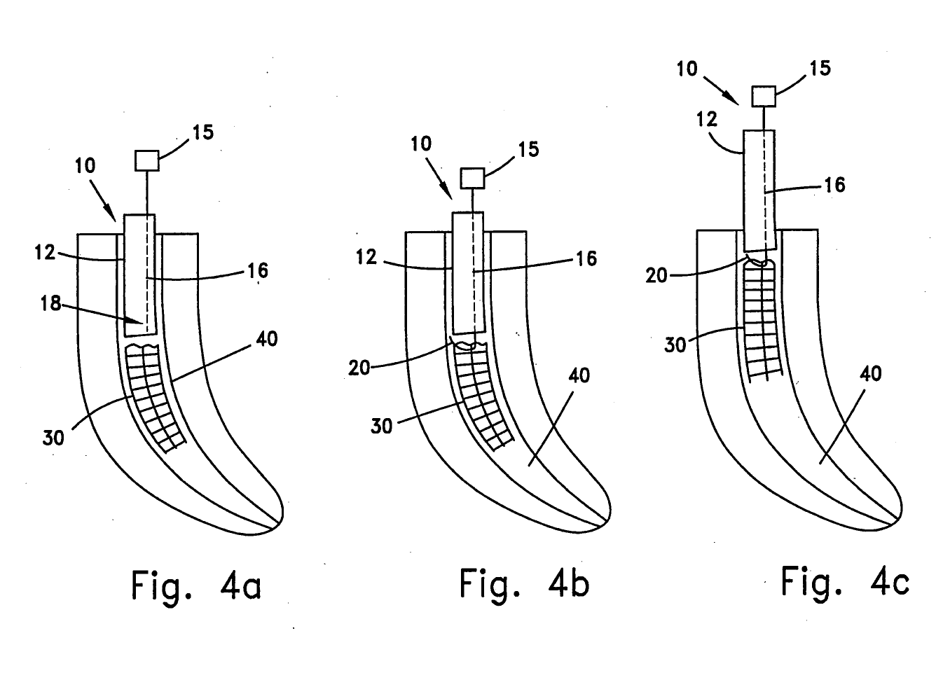

When in use, as shown in FIG. 3b, the file could break, leaving a piece lodged in the root canal (40) as shown in FIG. 3c. FIGS. 4a through 4c show the sequence of operations required for removing a broken piece (30) of the file from canal (40) using extraction system (10). Extraction system (10), in its initial configuration (FIG. 4a), is inserted into the open end of canal (40), preferably until contact is made between overtube (12) and broken piece (30). For clarity, overtube (12) is shown in FIGS. 4a to 4c in close proximity to, but not in contact with file (30). Handle (15) is pushed down, urging wire (14) in the direction of broken piece (30), until insertion end (18) extends out of overtube (12) into the hollow interior of broken piece (30) (FIG. 4b), where it assumes its working configuration, i.e. the shape of hook (20). Hook (20) catches, or, hooks one of the openings of the lattice-like structure. FIG. 4c shows extraction system (10) being withdrawn from root canal (40), removing the broken piece (30) of the file along with it.

If hook (20) does not catch one of the openings on the first try, the user may simply remove the system (10) from canal (40), reinsert wire (14) within overtube (12) and attempt to retrieve the broken piece (30) of the file again.

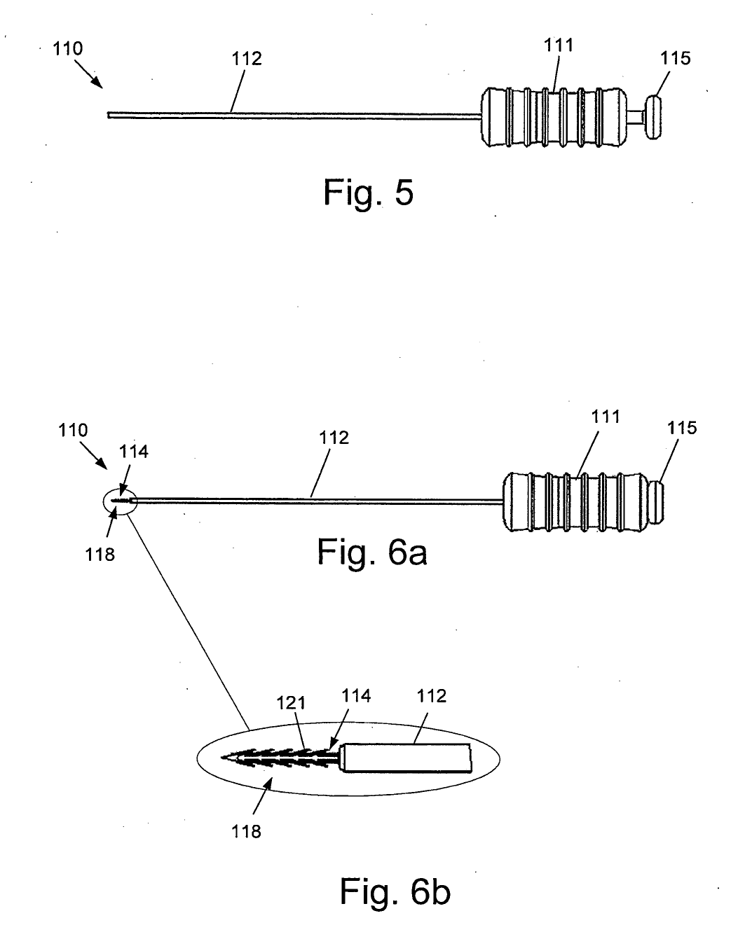

A preferred embodiment is shown in FIGS. 5, 6a and 6b, comprising all of the elements of the first embodiment, mutatis mutandis, with the following differences. FIG. 5 shows extraction system (110) in an initial configuration and FIG. 6a shows extraction system (110) in its working configuration. FIG. 6b shows the insertion end (118) of wire (114) in FIG. 6a in an enlarged view. Overtube (112) comprises a gripping portion (111) at its proximal end. Handle portion (115) is separated from gripping portion (111), as shown in FIG. 5, when extraction system (110) is in its initial configuration. Handle portion (115) is pressed toward gripping portion (111) to push insertion end (118) out of the overtube shifting extraction system (110) into its working configuration.

As seen in FIG. 6b, insertion end (118) comprises a plurality of catching members in the form of spikes (121) protruding at an angle from wire (114) for at least a portion of its longitudinal length. When spikes (121) are situated within overtube (112) (FIG. 5), they are maintained in a straight configuration by the small inner diameter of overtube (112), essentially parallel to wire (114). When situated outside of overtube (112), spikes (121) spring outward to their open configuration such that an object may be caught thereon. Alternatively, in another aspect, only one spike (121) may protrude from insertion end (118) of wire (114).

The design of this embodiment, in which in the initial configuration the spikes are collapsed parallel to wire (114), allows the diameter of overtube tube (112) to be minimized. This in turn allows the overtube to be inserted into the root canal until it touches the top of the broken piece of the file. When insertion end (118) is pushed out of the overtube the spikes deploy inside the hollow interior of the broken piece and when the extractor is pulled the spikes will lock onto the lattice or other protrusions on the interior walls of the piece to be extracted.

As with the first embodiment, preferably, at least insertion end (118) of wire (114) is made of a shape memory material, e.g. nickel titanium alloy (Nitinol). Wire (114) is treated such that its preferred shape memory shape is that shown in FIG. 6b. When inserted to overtube (112), spikes (121) are in a straight configuration and when handle (115) is pushed downward forcing spikes (121) out of the confines of overtube (112), the stress in the material is released, allowing it to assume its preferred shape.

It should be noted that it is not necessary for the object that is required to be removed from the enclosed space to comprise a lattice-like structure. However, the object must have a hollow interior and have on its inner surface some form of protrusion that hook (20) or spikes (121) can catch onto, allowing the object to be pulled out.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. An extraction system for removing an object having a hollow interior from an enclosed space, said system comprising:
a. an overtube that is at least partially insertable into said enclosed space, wherein the external diameter of said overtube is less than the minimum diameter of the enclosed space from its opening to the top of said object situated within said space; and,
b. a wire situated within said overtube, said wire comprising an elongated portion, a handle and an insertion end comprising one or more catching members;
wherein, said catching member is in a straight configuration when said insertion end is within said overtube, and said catching member assumes an open configuration when said insertion end is situated out of said overtube.

2. A system according to claim 1, wherein at least the insertion end is made of a shape memory material.

3. A system according to claim 2, wherein the insertion end is made of Nitinol.

4. A system according to claim 1, wherein the catching member may be chosen from any one of the group consisting of:
a. a hook; and,
b. a spike.

5. A system according to claim 1, wherein the enclosed space is a root canal.

6. A system according to claim 1, wherein the object is a broken piece of an endodontic file.

7. A system according to claim 6, wherein the file has an open lattice-like structure.

8. A method of removing an object having a hollow interior from an enclosed space, said method comprising:
a. providing an extraction system comprising:
1) an overtube that is at least partially insertable into said enclosed space, wherein the external diameter of said overtube is less than the minimum diameter of the enclosed space from its opening to the top of said object situated within said space; and,
2) a wire situated within said overtube, said wire comprising an elongated portion, a handle and an insertion end comprising one or more catching members;
wherein, said catching member is in a straight configuration when said insertion end is within said overtube, and said catching member assumes an open configuration when said insertion end is situated out of said overtube.
b. inserting the wire into the overtube such that the catching member is in its straight configuration;
c. inserting said overtube with said wire inside into the open end of the enclosed space until said overtube contacts said object;
d. pushing said wire until said insertion end of said wire exits said overtube, thereby allowing said catching member to assume to its open configuration inside said hollow interior of said object;
e. pulling slowly on said wire until said catching member catches an opening in the wall of said object or on a protrusion on the inner wall of said object; and,
f. withdrawing said system and said attached object from said enclosed space.
